(19) United States
(12) Patent Application Publication
(10) Pub. No.: US 2011/0019894 A1
(43) Pub. Date: Jan. 27, 2011

(54) ULTRASONIC DIAGNOSTIC APPARATUS AND CONTROL PROGRAM THEREOF

(76) Inventor: Shunichiro Tanigawa, Tokyo (JP)

Correspondence Address: PATRICK W. RASCHE (20459);ARMSTRONG TEASDALE LLP, 7700 Forsyth Boulevard, Suite 1800, St. Louis, MO, 63105, US

(21) Appl. No.: 12/841,896

(22) Filed: Jul. 22, 2010

(30) Foreign Application Priority Data
Jul. 22, 2009 (JP) 2009-170893

(51) Int. Cl. G06K 9/00

(52) U.S. Cl. 382/131

(57) ABSTRACT

An ultrasonic diagnostic apparatus includes a physical quantity calculator for setting correlation windows to echo signals via ultrasound of a biological tissue and lying on the same sound rays which belong to frames different in time, and performing a correlation arithmetic operation between the correlation windows to calculate a physical quantity related to elasticity of the biological tissue, and an elastic image data generator for generating elastic image data of the biological tissue, based on the physical quantity. Upon setting each correlation window to the echo signal on one sound ray which belongs to either one of the frames, the physical quantity calculator sets the each correlation window using a correlation arithmetic operation on an immediately preceding correlation window adjacent to the correlation window on one sound ray and previously subjected to a correlation arithmetic operation, and a correlation arithmetic operation on another sound ray correlation window.

### CROSS REFERENCE TO RELATED APPLICATIONS

This application claims the benefit of Japanese Patent Application No. 2009-170893 filed Jul. 22, 2009, which is hereby incorporated by reference in its entirety.

### BACKGROUND OF THE INVENTION

The present invention relates to an ultrasonic diagnostic apparatus, and particularly to an ultrasonic diagnostic apparatus that displays an elastic image indicative of the hardness or softness of a biological tissue and its control program.

An ultrasonic diagnostic apparatus, which combines a normal B-mode image and an elastic image indicative of the hardness or softness of a biological tissue together and displays the result of combination, has been disclosed in, for example, Japanese Unexamined Patent Publication No. 2005-118152. In this type of ultrasonic diagnostic apparatus, the elastic image is generated in the following manner. First, ultrasound is transmitted and received to and from the biological tissue while repeating pressure from a body surface by an ultrasonic probe and its relaxation to thereby acquire echo signals. Then, a physical quantity related to the elasticity of the biological tissue is calculated based on the acquired echo signals. The physical quantity is converted into hue information to thereby form a color elastic image. Incidentally, for example, a displacement based on deformation of the biological tissue (hereinafter called simply “displacement”) or the like is calculated as the physical quantity related to the elasticity of the biological tissue.

One example of a method for calculating the physical quantity will be explained a little more. Correlation windows each having a width corresponding to a predetermined number of data are first respectively set to two echo signals on the same sound rays that belong to two frames different in time from each other. A correlation arithmetic operation is performed between the correlation windows to calculate the physical quantity. In Japanese Unexamined Patent Publication No. 2008-126079, for example, a correlation arithmetic operation is performed between correlation windows to thereby calculate a shift in waveform between both echo signals. This shift in waveform is assumed to be a displacement.

The correlation windows are sequentially set in a sound ray direction and a correlation arithmetic operation is carried out for each correlation window to calculate the physical quantity. Now, in Japanese Unexamined Patent Publication No. 2008-126079, an echo signal that belongs to one frame, of two echo signals belonging to different frames is moved by a predetermined amount from immediately preceding correlation windows adjacent to each other, on which a correlation arithmetic operation has been performed just previously on the same sound ray, to thereby perform the setting of the correlation windows. On the other hand, the amount of movement of the echo signal that belongs to the other frame from the corresponding immediately preceding correlation window is determined using the physical quantity obtained by the correlation arithmetic operation targeted for the immediately preceding correlation window, whereby the corresponding correlation window is set (refer to the paragraph [0044] of Japanese Unexamined Patent Publication No. 2008-126079). As the degree of matching between the correlation windows set to the echo signals belonging to the two frames in this way becomes higher, a correlation coefficient at the correlation arithmetic operation becomes high. Thus, the resulting calculated value becomes a calculated value on which the elasticity of a biological tissue has been reflected more accurately.

Meanwhile, when the quality of an echo signal is worse, the degree of matching between correlation windows becomes low so that a correlation arithmetic operation low in correlation coefficient is reached. It is thus not possible to acquire a physical quantity on which the elasticity of a biological tissue has been reflected accurately. When, for example, a locally hard portion exists in the biological tissue due to calcification or the like, the hard portion may be shifted in a lateral direction due to pressure by the ultrasonic probe and its relaxation. Since, in this case, the waveform of an echo signal at the shifted portion differs between the two frames, the degree of matching between the correlation windows on which the corresponding correlation arithmetic operation is performed, becomes reduced and the correlation coefficient becomes low. Even when a correlation arithmetic operation is performed on each correlation window set to a portion low in signal intensity, the degree of matching becomes reduced in a manner similar to the above and the correlation coefficient becomes low. Thus, when the quality of the echo signal is worse, the correlation coefficient at the correlation arithmetic operation becomes low and hence the calculated physical quantity is not brought to one on which the elasticity of the biological tissue has been reflected accurately.

Now, when the degree of matching between the immediately preceding correlation windows is low and a physical quantity obtained by its correlation arithmetic operation is not brought to one on which the elasticity of a biological tissue has been reflected accurately, a correlation coefficient at a correlation arithmetic operation on the following correlation window set based on the physical quantity also becomes low and a physical quantity obtained as a result of its arithmetic operation is not brought to one on which the elasticity of the biological tissue has been reflected accurately. Thus, when a correlation window at which a physical quantity on which the elasticity of a biological tissue has been reflected accurately is not obtained exists on a given sound ray, the degree of matching between correlation windows set subsequent to the correlation window remains in a low state depending on the signal waveform and linear artifacts may appear on an elastic image.

It is desirable that the problems described previously are solved.

### BRIEF DESCRIPTION OF THE INVENTION

The invention according to a first aspect provides an ultrasonic diagnostic apparatus including a physical quantity calculator for setting correlation windows to two echo signals obtained by transmission/reception of ultrasound to and from a biological tissue and lying on the same sound rays which belong to two frames different in time, and performing a correlation arithmetic operation between the correlation windows to thereby calculate a physical quantity related to elasticity of the biological tissue, and an elastic image data generator for generating elastic image data of the biological tissue, based on the physical quantity, wherein upon setting each correlation window to the echo signal on one sound ray which belongs to either one of the two frames, the physical quantity calculator sets each correlation window in accordance with a correlation arithmetic operation on an immediately preceding correlation window adjacent to the correlation window on the one sound ray and subjected to a correlation arithmetic operation just previously, and a correlation arithmetic operation on other sound ray correlation window on other sound ray different from the one sound ray.

The invention according to a second aspect provides an ultrasonic diagnostic apparatus wherein in the invention according to the first aspect, the ultrasonic diagnostic apparatus includes an average arithmetic unit for performing an average arithmetic operation on a calculated value obtained by the correlation arithmetic operation on the immediately preceding correlation window and a calculated value obtained by the correlation arithmetic operation on the other sound ray correlation window upon the setting of each correlation window on the one sound ray, and wherein the physical quantity calculator performs the setting of the correlation window, based on an average value obtained by the average arithmetic unit.

The invention according to a third aspect provides an ultrasonic diagnostic apparatus wherein in the invention according to the second aspect, the average arithmetic unit performs an average arithmetic operation on calculated values obtained by correlation arithmetic operations on the other sound ray correlation windows about a plurality of the other sound rays and calculated values each obtained by the correlation arithmetic operation on the immediately preceding correlation window.

The invention according to a fourth aspect provides an ultrasonic diagnostic apparatus wherein in the invention according to the third aspect, the ultrasonic diagnostic apparatus includes an error determinator for determining whether each of the calculated values obtained by the correlation arithmetic operations on the other sound ray correlation windows is in error, and wherein the average arithmetic unit performs the average arithmetic operation except for the calculated value of error.

The invention according to a fifth aspect provides an ultrasonic diagnostic apparatus wherein in the invention according to the first aspect, the ultrasonic diagnostic apparatus includes an error determinator for determining whether the calculated value obtained by the correlation arithmetic operation on the immediately preceding correlation window is in error, and an average arithmetic unit for, when it is determined by the error determinator that the calculated value obtained by the correlation arithmetic operation on the immediately preceding correlation window is in error upon the setting of the correlation window on the one sound ray, performing an average arithmetic operation on the calculated values obtained by the correlation arithmetic operations on the other sound ray correlation windows about a plurality of the other sound rays, and wherein the physical quantity calculator sets the correlation window, based on an average value obtained by the average arithmetic unit.

The invention according to a sixth aspect provides an ultrasonic diagnostic apparatus wherein in the invention according to the fourth or fifth aspect, the error determinator determines based on a correlation coefficient at a correlation arithmetic operation by which a calculated value targeted for determination is obtained, whether the calculated value is in error.

The invention according to a seventh aspect provides an ultrasonic diagnostic apparatus wherein in the invention according to the fourth or fifth aspect, the error determinator determines that a calculated value targeted for determination is in error when the calculated value falls beyond a predetermined range.

The invention according to an eighth aspect provides an ultrasonic diagnostic apparatus wherein in the invention according to the fourth or fifth aspect, the error determinator determines based on a distribution of other calculated values target for determination whether a calculated value targeted for determination is in error.

The invention according to a ninth aspect provides an ultrasonic diagnostic apparatus wherein in the invention according to any one of the second to eighth aspects, the average arithmetic unit assigns weights corresponding to correlation coefficients to the calculated values, respectively, targeted for the average arithmetic operation.

The invention according to a tenth aspect provides an ultrasonic diagnostic apparatus wherein in the invention according to the first aspect, the ultrasonic diagnostic apparatus includes a selector for selecting a calculated value suitable for the setting of each correlation window out of a calculated value obtained by the correlation arithmetic operation on the immediately preceding correlation window and a calculated value obtained by the correlation arithmetic operation on the other sound ray correlation window upon the setting of the correlation window on the one sound ray, and wherein the physical quantity calculator performs the setting of the correlation window, based on the calculated value selected by the selector.

The invention according to an eleventh aspect provides an ultrasonic diagnostic apparatus wherein in the invention according to the tenth aspect, the selector performs a selection of a calculated value suitable for the setting of the correlation window, based on a correlation coefficient for a correlation arithmetic operation by which the calculated value is obtained or whether the calculated value falls within a predetermined range.

The invention according to a twelfth aspect provides an ultrasonic diagnostic apparatus wherein in the invention according to the tenth or eleventh aspect, when the corresponding correlation coefficient at the correlation arithmetic operation on the immediately preceding correlation windows exceeds a predetermined threshold value, the selector selects the calculated value obtained by the correlation arithmetic operation on the immediately preceding correlation windows as the calculated value suitable for the setting of each of the correlation windows, whereas when the corresponding correlation coefficient at the correlation arithmetic operation on the immediately preceding correlation windows is less than or equal to the predetermined threshold value, the selector selects a calculated value obtained by a correlation arithmetic operation for a correlation coefficient higher than the correlation coefficient at the correlation arithmetic operation on the immediately preceding correlation windows or a calculated value lying within a predetermined range, the calculated value corresponding to the calculated value obtained by the correlation arithmetic operation on the other sound ray correlation windows, as the calculated value suitable for the setting of each of the correlation windows.

The invention according to a thirteenth aspect provides an ultrasonic diagnostic apparatus wherein in the invention according to the tenth or eleventh aspect, the selector selects a calculated value obtained by a correlation arithmetic operation for the highest correlation coefficient of the correlation coefficient at the correlation arithmetic operation on the immediately preceding correlation windows and the correlation coefficients at the correlation arithmetic operations on the other sound ray correlation windows, as the calculated value suitable for the setting of each of the correlation windows.

The invention according to a fourteenth aspect provides an ultrasonic diagnostic apparatus wherein in the invention according to the tenth or eleventh aspect, when the calculated value obtained by the correlation arithmetic operation on the immediately preceding correlation windows falls within a predetermined range, the selector selects the calculated value obtained by the correlation arithmetic operation on the immediately preceding correlation windows as the calculated value suitable for the setting of each of the correlation windows, whereas when the calculated value obtained by the correlation arithmetic operation on the immediately preceding correlation windows falls beyond the predetermined range, the selector selects, as the calculated value suitable for the setting of each of the correlation windows, a calculated value obtained by a correlation arithmetic operation for a correlation coefficient higher than the correlation coefficient at the correlation arithmetic operation on the immediately preceding correlation windows or a calculated value lying within the predetermined range, the calculated value corresponding to each of the calculated values obtained by the correlation arithmetic operation on the other sound ray correlation windows.

The invention according to a fifteenth aspect provides an ultrasonic diagnostic apparatus wherein in the invention according to the tenth or eleventh aspect, the selector determines based on a distribution of calculated values obtained by correlation arithmetic operations on the other sound ray correlation windows about a plurality of the other sound rays, whether the calculated value obtained by the correlation arithmetic operation on the immediately preceding correlation windows is suitable for the setting of each of the correlation windows, and when it is determined that the calculated value is suitable for the setting of each of the correlation windows, the selector selects the calculated value obtained by the correlation arithmetic operation on the immediately preceding correlation windows as the calculated value suitable for the setting of each of the correlation windows, whereas when it is determined that the calculated value is unsuitable for the setting of each of the correlation windows, the selector selects, as the calculated value suitable for the setting of each of the correlation windows, a calculated value obtained by a correlation arithmetic operation for a correlation coefficient higher than the correlation coefficient at the correlation arithmetic operation on the immediately preceding correlation windows or a calculated lying within the predetermined range, the calculated value corresponding to any of the calculated values obtained by the correlation arithmetic operations on the other sound ray correlation windows.

The invention according to a sixteenth aspect provides an ultrasonic diagnostic apparatus wherein in the invention according to any one of the first to fifteenth aspects, the other sound ray correlation windows are respectively located in the same depth as the immediately preceding correlation windows in the biological tissue.

The invention according to a seventeenth aspect provides a control program for an ultrasonic diagnostic apparatus, the control program allows a computer to execute the following functions: a physical quantity calculating function for setting correlation windows to two echo signals obtained by transmission/reception of ultrasound to and from a biological tissue and lying on the same sound rays which belong to two frames different in time and performing a correlation arithmetic operation between the correlation windows to thereby calculate a physical quantity related to elasticity of the biological tissue, and an elastic image data generating function for generating elastic image data of the biological tissue, based on the physical quantity, wherein upon setting each correlation window to the echo signal on one sound ray which belongs to either one of the two frames, the physical quantity calculating function sets the correlation window in accordance with a correlation arithmetic operation on an immediately preceding correlation window adjacent to the correlation window on the one sound ray and subjected to a correlation arithmetic operation just previously, and a correlation arithmetic operation on other sound ray correlation window on other sound ray different from the one sound ray.

The invention according to an eighteenth aspect provides a control program for an ultrasonic diagnostic apparatus, wherein in the invention according to the seventeenth aspect, the control program further allows the computer to execute an average computing function for performing an average arithmetic operation on a calculated value obtained by the correlation arithmetic operation on the immediately preceding correlation window and a calculated value obtained by the correlation arithmetic operation on the other sound ray correlation window upon the setting of each correlation window on the one sound ray, and wherein the physical quantity calculating function performs the setting of the correlation window, based on an average value obtained by the average computing function.

The invention according to a nineteenth aspect provides a control program for an ultrasonic diagnostic apparatus, wherein in the invention according to the seventeenth aspect, the control program further allows the computer to execute an error determining function for determining whether the calculated value obtained by the correlation arithmetic operation on the immediately preceding correlation window is in error, and an average computing function for, when it is determined by the error determining function that the calculated value obtained by the correlation arithmetic operation on the immediately preceding correlation window is in error upon the setting of each correlation window on the one sound ray, performing an average arithmetic operation on the calculated values obtained by the correlation arithmetic operations on the other sound ray correlation windows about a plurality of the other sound rays, and wherein the physical quantity calculating function sets the correlation window, based on an average value obtained by the average computing function.

The invention according to a twentieth aspect provides a control program for an ultrasonic diagnostic apparatus, wherein in the invention according to the seventeenth aspect, the control program further allows the computer to execute a selecting function for selecting a calculated value suitable for the setting of each correlation window out of a calculated value obtained by the correlation arithmetic operation on the immediately preceding correlation window and a calculated value obtained by the correlation arithmetic operation on the other sound ray correlation window upon the setting of each correlation window on the one sound ray, and wherein the physical quantity calculating function performs the setting of the correlation window, based on the calculated value selected by the selecting function.

According to the invention, upon setting each correlation window on the one sound ray, the physical quantity calculator sets the corresponding correlation window in accordance with the correlation arithmetic operation on the immediately preceding correlation window adjacent to the correlation window on the one sound ray and the correlation arithmetic operation on the other sound ray correlation window on other sound ray different from the one sound ray. Thus, if each of the calculated values obtained by the correlation arithmetic operations on the other sound ray correlation windows is one on which the elasticity of the biological tissue has been reflected more accurately, even where the calculated value obtained from the result of the correlation arithmetic operation on the immediately preceding correlation windows is not one on which the elasticity of the biological tissue has been reflected accurately, the correlation window on the one sound ray can be set in such a manner that the degree of matching between the correlation windows subjected to the correlation arithmetic operation becomes higher than conventional. It is thus possible to suppress the appearance of linear artifacts on an elastic image and acquire an elastic image on which the elasticity of the biological tissue has been reflected more accurately than conventional.

According to the invention as well, upon the setting of each correlation window on the one sound ray, the average arithmetic unit performs an average arithmetic operation on the calculated value obtained by the correlation arithmetic operation on the immediately preceding correlation window and the calculated value obtained by the correlation arithmetic operation on the other sound ray correlation window. The physical quantity calculator performs the setting of the correlation window, based on an average value obtained by the average arithmetic unit. Thus, if each of the calculated values obtained by the correlation arithmetic operations on the other sound ray correlation windows is one on which the elasticity of the biological tissue has been reflected more accurately, even where the calculated value obtained from the result of the correlation arithmetic operation on the immediately preceding correlation windows is not one on which the elasticity of the biological tissue has been reflected accurately, the correlation window on the one sound ray can be set in such a manner that the degree of matching between the correlation windows subjected to the correlation arithmetic operation becomes higher than conventional. It is thus possible to suppress the appearance of linear artifacts on an elastic image and acquire an elastic image on which the elasticity of the biological tissue has been reflected more accurately than conventional.

Further, according to the invention, when the calculated value obtained by the correlation arithmetic operation on the immediately preceding correlation windows is determined to be in error by the error determinator upon setting each correlation window on the one sound ray, the average arithmetic unit performs an average arithmetic operation on the calculated values obtained by correlation arithmetic operations on the other sound ray correlation windows about a plurality of the other sound rays. The physical quantity calculator performs the setting of the correlation window, based on an average value obtained by the average arithmetic unit. Thus, if each of the calculated values obtained by the correlation arithmetic operations on the other sound ray correlation windows is one on which the elasticity of the biological tissue has been reflected more accurately, even where the calculated value obtained from the result of the correlation arithmetic operation on the immediately preceding correlation windows is not one on which the elasticity of the biological tissue has been reflected accurately, the correlation window on the one sound ray can be set in such a manner that the degree of matching between the correlation windows subjected to the correlation arithmetic operation becomes higher than conventional. It is thus possible to suppress the appearance of linear artifacts on an elastic image and acquire an elastic image on which the elasticity of the biological tissue has been reflected more accurately than conventional.

Furthermore, according to the invention, upon setting each correlation window on the one sound ray, the selector selects the corresponding calculated value suitable for the setting of the correlation window out of the calculated value obtained by the correlation arithmetic operation on the immediately preceding correlation windows and the calculated values obtained by the correlation arithmetic operations on the other sound ray correlation windows. The physical quantity calculator sets the correlation window based on the selected calculated value. Thus, if each of the calculated values obtained by the correlation arithmetic operations on the other sound ray correlation windows is one on which the elasticity of the biological tissue has been reflected more accurately, even where the calculated value obtained from the result of the correlation arithmetic operation on the immediately preceding correlation windows is not one on which the elasticity of the biological tissue has been reflected accurately, each of the calculated values obtained by the correlation arithmetic operations on the other sound ray correlation windows is selected as the calculated value suitable for the setting of the correlation window. Consequently, the correlation window on the one sound ray can be set in such a manner that the degree of matching between the correlation windows subjected to the correlation arithmetic operation becomes higher than conventional. It is thus possible to suppress the appearance of linear artifacts on an elastic image and acquire an elastic image on which the elasticity of the biological tissue has been reflected more accurately than conventional.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing a schematic configuration of a first embodiment of an ultrasonic diagnostic apparatus according to the invention.

FIG. 2 is a block diagram illustrating a configuration of an elastic image processing unit of the ultrasonic diagnostic apparatus shown in FIG. 1.

FIG. 3 is a diagram depicting an ultrasonic image displayed on a display unit.

FIG. 4 is a diagram for describing the setting of correlation windows at the generation of elastic image data.

FIG. 5 is a diagram for describing the setting of correlation windows at the generation of elastic image data.

FIG. 6 is a diagram for describing the setting of correlation windows at the generation of elastic image data.

FIG. 7 is a block diagram showing a configuration of an elastic image processing unit according to a modification of the first embodiment.

FIG. 8 is a block diagram illustrating a configuration of an elastic image processing unit according to a second embodiment.

### DETAILED DESCRIPTION OF THE INVENTION

Embodiments of the invention will hereinafter be explained in detail based on the accompanying drawings.

### First Embodiment

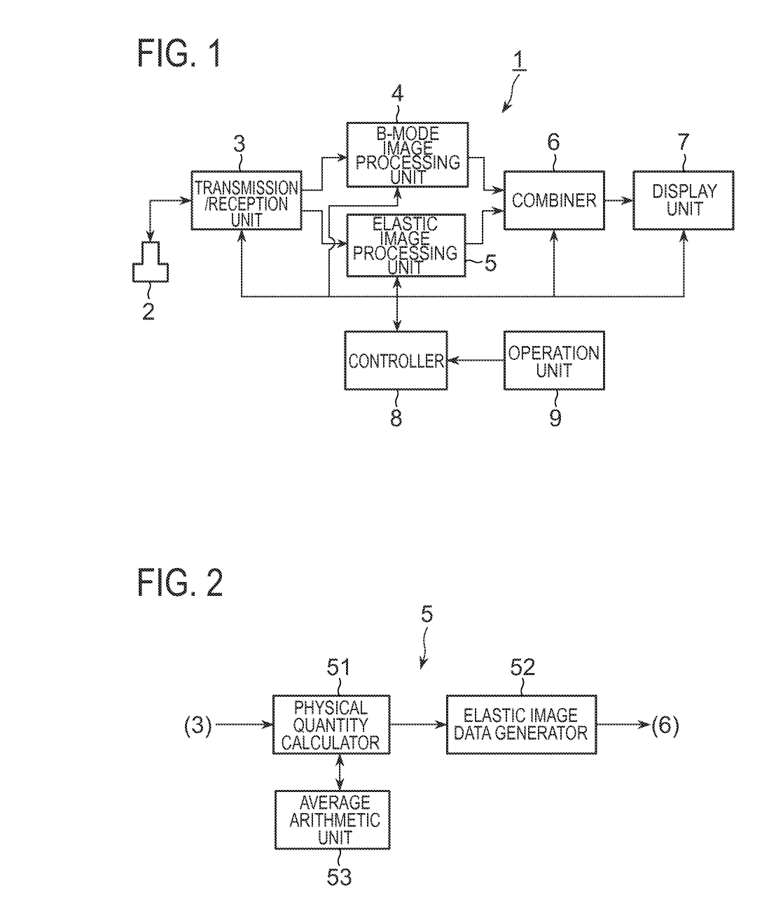

A first embodiment will first be explained based on FIGS. 1 through 6. An ultrasonic diagnostic apparatus 1 shown in FIG. 1 is equipped with an ultrasonic probe 2, a transmission/reception unit 3, a B-mode image processing unit 4, an elastic image processing unit 5, a combiner 6 and a display unit 7. Further, the ultrasonic diagnostic apparatus 1 includes a controller 8 and an operation unit 9.

The ultrasonic probe 2 transmits ultrasound to a biological tissue and receives its echoes. An elastic image is generated as described later based on echo signals acquired by performing the transmission/reception of the ultrasound while repeating pressure and relaxation in a state in which the ultrasonic probe 2 is being brought into contact with the surface of the biological tissue.

The transmission/reception unit 3 drives the ultrasonic probe 2 under a predetermined scan condition to perform the scanning of the ultrasound every sound ray. The transmission/reception unit 3 performs signal processing such as phasing-adding processing on each echo signal received by the ultrasonic probe 2.

Incidentally, the transmission/reception unit 3 separately performs a scan for generating a B-mode image and a scan for generating an elastic image. As the scan for generating the elastic image, scanning is performed twice on the same sound ray in a region for generating an elastic image for a subject.

The B-mode image processing unit 4 performs B-mode processing such as logarithmic compression processing, envelop detection processing or the like on the echo signals outputted from the transmission/reception unit 3 to thereby generate B-mode image data.

The elastic image processing unit 5 generates elastic image data, based on the echo signals outputted from the transmission/reception unit 3. As shown in FIG. 2, the elastic image processing unit 5 has a physical quantity calculator 51 and an elastic image data generator 52. Further, the elastic image processing unit 5 has an average arithmetic unit 53.

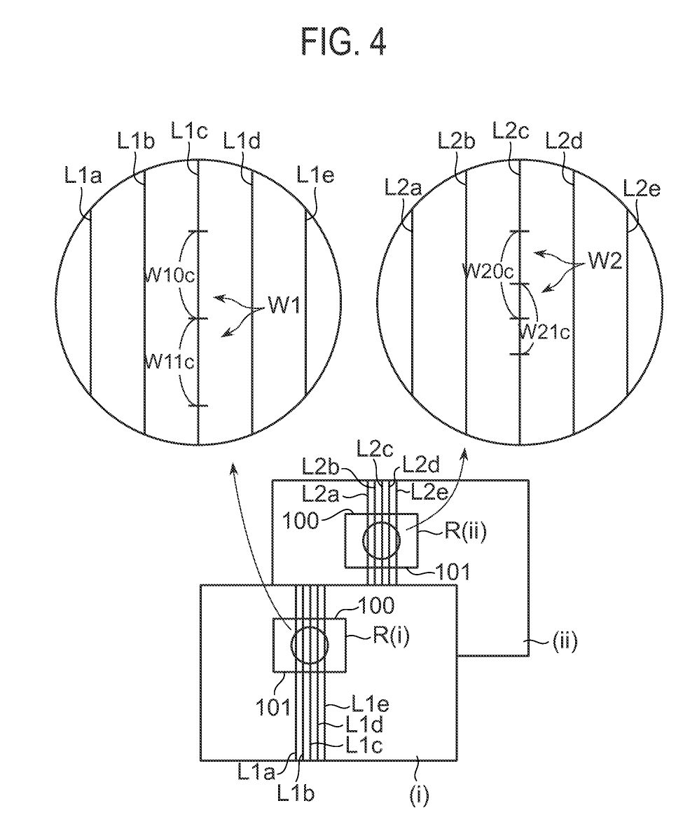

The physical quantity calculator 51 calculates displacements (hereinafter called simply “displacements”) due to deformation of respective parts or regions of a biological tissue, produced by the pressure by the ultrasonic probe 2 and its relaxation, as physical quantities related to the elasticity of the respective regions in the biological tissue (displacement calculating function). The physical quantity calculator 51 calculates displacements, based on two echo signals on the same sound rays that belong to two frames (i) and (ii) different in time as shown in FIG. 4 used in the aftermentioned description. The details thereof will be explained later. The physical quantity calculator 51 is one example illustrative of an embodiment of a physical quantity calculator in the invention. The displacement calculating function is one example illustrative of an embodiment of a physical quantity calculating function in the invention.

The elastic image data generator 52 converts the displacement calculated by the physical quantity calculator 51 into hue information and generates elastic image data in an elastic image generating region (elastic image data generating function). The elastic image data generator 52 is one example of an embodiment of an elastic image data generator in the invention. The elastic image data generating function is one example of an embodiment of an elastic image data generating function in the invention.

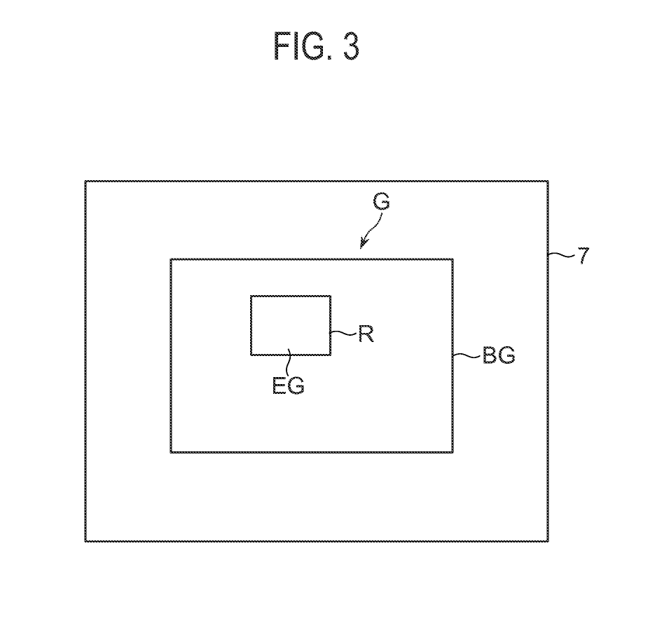

Now, in the present embodiment, a region of interest (ROI) R is set onto a B-mode image BG displayed on the display unit 7 as shown in FIG. 3. The elastic image data is formed in the region of interest R. The invention is however not limited to where the elastic image is generated with respect to part of the B-mode image BG in this way, but the elastic image data may be formed over the entire B-mode image BG.

The average arithmetic unit 53 performs an average arithmetic operation on a displacement (displacement Xc to be described later) obtained by a correlation arithmetic operation on immediately preceding correlation windows and displacements (displacements Xa, Xb, Xd and Xe to be described later) obtained by correlation arithmetic operations on other sound-ray correlation windows (average computing function). Its details will be explained later. The average arithmetic unit 53 is one example of an embodiment of an average arithmetic unit in the invention.

The B-mode image data generated by the B-mode image processing unit 4 and the elastic image data generated by the elastic image processing unit 5 are combined together by the combiner 6. Described concretely, the combiner 6 adds the B-mode image data and the elastic image data corresponding to one frame together to generate ultrasonic image data corresponding to one frame displayed on the display unit 7. Then, the ultrasonic image data obtained at the combiner 6 is displayed on the display unit 7 as an ultrasonic image G obtained by combining a monochrome B-mode image BG and a color elastic image EG as shown in FIG. 3. In the present embodiment, the elastic image EG is displayed within the region of interest R in a translucent form (in a state in which the background B-mode image is transparent).

The controller 8 includes a CPU (Central Processing Unit). The controller 8 reads a control program stored in an unillustrated storage unit and causes the same to execute the displacement calculating function, the elastic image data generating function and the average computing function and to execute functions of the respective parts of the ultrasonic diagnostic apparatus 1 in addition to them. The operation unit 9 includes a keyboard and a pointing device (not shown) for causing an operator to input instructions and information.

The operation of the ultrasonic diagnostic apparatus 1 according to the present embodiment will now be explained. First, the transmission/reception unit 3 transmits ultrasound from the ultrasonic probe 2 to the biological tissue of the subject and acquires its echo signals. At this time, the transmission/reception of the ultrasound is performed through the ultrasonic probe 2 while repeating the pressure to the subject and its relaxation.

When the echo signals are acquired, the B-mode image processing unit 4 generates B-mode image data, based on the echo signals from the transmission/reception unit 3. The elastic image processing unit 5 generates elastic image data, based on the echo signals from the transmission/reception unit 3. The B-mode image data and the elastic image data are combined together at the combiner 6, and an ultrasonic image G obtained by combining a B-mode image BG and an elastic image EG together is displayed on the display unit 7 as shown in FIG. 3.

The generation of the elastic image data at the elastic image processing unit 5 will be explained in detail. The frames (i) and (ii) shown in FIG. 4 respectively include echo signals acquired on a plurality of sound rays. In FIG. 4, five sound rays L1a, L1b, L1c, L1d and L1e are shown as some of the sound rays in the frame (i). Sound rays L2a, L2b, L2c, L2d and L2e are shown as sound rays corresponding to the sound rays L1a through L1e in the frame (ii). Namely, the sound rays L1a and L2a, the sound rays L1b and L2b, the sound rays L1c and L2c, the sound rays L1d and L2d, and the sound rays L1e and L2e respectively correspond to the same sound rays that belong to the two frames different from each other. In FIG. 4, R (i) and R (ii) indicate regions each corresponding to the region of interest R.

A description will now be made of, as an example, where elastic image data on the sound rays L1c and L2c are generated. The physical quantity calculator 51 sets correlation windows W1 and W2 to echo signals 51 and S2 (not shown) on the sound rays L1c and L2c respectively and performs a correlation arithmetic operation between the correlation windows W1 and W2 to thereby calculate the displacement. The elastic image data generator 52 generates elastic image data corresponding to one pixel, based on the displacement.

The setting of the correlation windows W1 and W2 will be explained. The physical quantity calculator 51 sequentially sets correlation windows W1 from an upper end portion 100 of the region R (i) on the sound ray L1c to its lower end portion 101 and sequentially sets correlation windows W2 from an upper end portion 100 of the region R (ii) on the sound ray L2c and its lower end portion 101.

This will be explained in further detail. A description will now be made of, as an example, where correlation windows W11c and W21c are respectively set to the echo signals S1 and S2 on the sound rays L1c and L2c as shown in FIG. 4. Incidentally, the correlation windows are set to their corresponding echo signals that belong to the frame (i) in a manner similar to the setting thereof to the echo signal S1 on the sound ray L1c. The correlation windows are set to their corresponding echo signals that belong to the frame (ii) in a manner to the setting thereof to the echo signal S2 on the sound ray L2c.

In FIG. 4, W10c and W20c are of correlation windows which are adjacent to the correlation windows W11c and W21c on the sound rays L1c and L2c and on which a correlation arithmetic operation is performed immediately before it. Here, the term “adjacent correlation windows” are indicative of correlation windows at which the turn of the setting of correlation windows is continuous. Correlation windows which are adjacent to correlation windows (correlation windows W11c and W21c herein) to be set, on the same sound rays and on which a correlation arithmetic operation is performed immediately before it, are assumed to be immediately preceding correlation windows. The immediately preceding correlation windows are of the correlation windows W10c and W20c herein. Namely, the correlation windows W10c and W20c are one example illustrative of embodiments of immediately preceding correlation windows in the invention.

First, the physical quantity calculator 51 moves the correlation window by a predetermined number of data defined in advance from the immediately preceding correlation window W10c to set the correlation window W11c. Here, the correlation window is moved by the number of data corresponding to a window width of the correlation window W10c to set the correlation window W11c. The window width of the correlation window W11c is identical to the window width of the correlation window W10c. Thus, the correlation windows W1 identical in window width are sequentially set to the echo signal S1 on the sound ray L1c from the upper end portion 100 to the lower end portion 101.

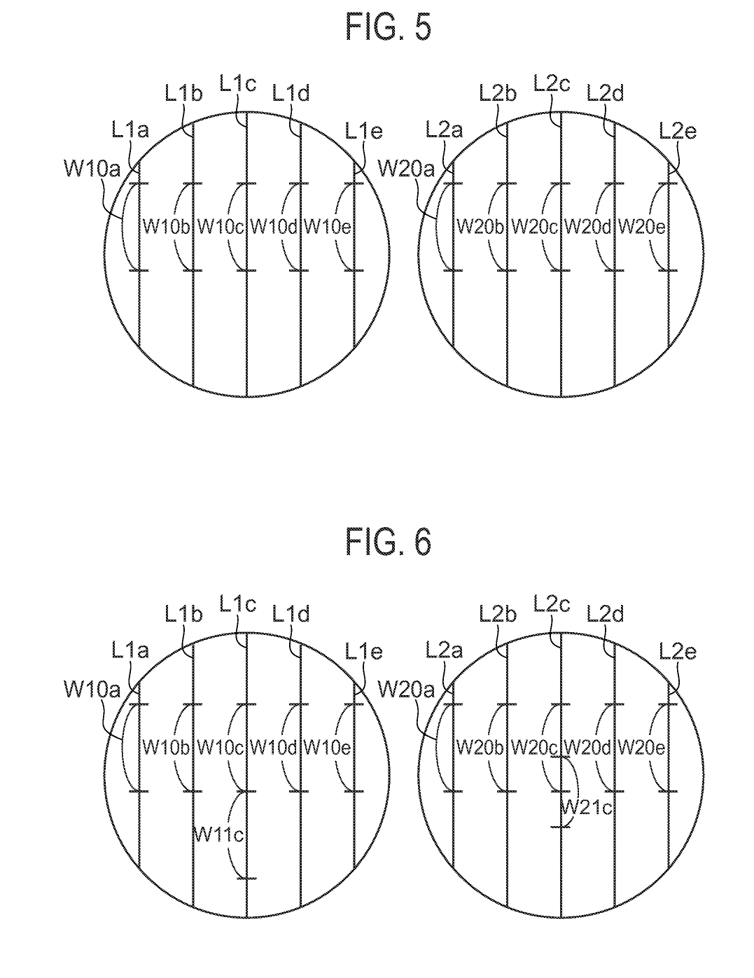

The setting of the correlation window W21c will next be described. Upon setting the correlation window W21c, as shown in FIG. 5, correlation windows are first respectively set to the sound rays L1a and L2a, the sound rays L1b and L2b, the sound rays L1d and L2d and the sound rays L1e and L2e different from the sound rays L1c and L2c at positions where they are brought to the same depths as the correlation windows W10c and W20c in the biological tissue. Described concretely, correlation windows W10a and W20a are respectively set to the sound rays L1a and L2a, correlation windows 10b and W20b are respectively set to the sound rays L1b and L2b, correlation windows W10d and W20d are respectively set to the sound rays L1d and L2d, and correlation windows W10e and W20e are respectively set to the sound rays L1e and L2e.

Now, correlation windows set to other sound rays different from the sound rays to which the correlation windows are set are assumed to be other sound ray correlation windows. Here, other sound ray correlation windows correspond to the correlation windows W10a and W20a, the correlation windows W10b and W20b, the correlation windows W10d and W20d and the correlation windows W10e and W20e and are respectively set to the same depths as the immediately preceding correlation windows in the biological tissue. The correlation windows W10a and W20a, the correlation windows W10b and W20b, the correlation windows W10d and W20d and the correlation windows W10e and W20e are one example illustrative of embodiments of other sound ray correlation windows in the invention.

Here, the correlation windows W10a and W20a, the correlation windows W10b and W20b, the correlation windows W10d and W20d and the correlation windows W10e and W20e corresponding to other sound ray correlation windows are not necessarily limited to those set to the same depths as the correlation windows W10c and W20c corresponding to the immediately preceding correlation windows in the biological tissue. It is however desirable that their positions in the depth direction are not excessively spaced from one another.

Incidentally, the sound rays L1c and L2c are one example illustrative of an embodiment of one sound ray in the invention here. The sound rays L1a and L2a, sound rays L1b and L2b, sound rays L1d and L2d and sound rays L1e and L2e are respectively one example illustrative of embodiments of other sound rays in the invention.

Next, the physical quantity calculator 51 performs a correlation arithmetic operation between the correlation windows W10a and W20a, a correlation arithmetic operation between the correlation windows W10b and W20b, a correlation arithmetic operation between the correlation windows W10d and W20d and a correlation arithmetic operation between the correlation windows W10e and W20e to thereby calculate displacements Xa, Xb, Xd and Xe respectively. Then, the average arithmetic unit 53 performs an average arithmetic operation on the displacements Xa, Xb, Xd and Xe and the displacement Xc obtained by the correlation arithmetic operation between the correlation windows W10c and W20c to thereby calculate an average value XAV of the individual displacements.

Incidentally, the displacements Xa, Xb, Xd and Xe related to the other sound ray correlation windows may be calculated by the physical quantity calculator 51 upon execution of the average arithmetic operation. When, however, the displacements Xa, Xb, Xd and Xe have already been calculated upon generation of elastic image data about other sound ray correlation windows, they need not to be calculated anew, and the values calculated at this time may be used for the average arithmetic operation.

Here, upon execution of the average arithmetic operation, the displacements Xa, Xb, Xc, Xd and Xe may be weighted according to correlation coefficients. Namely, assuming that a correlation coefficient at the correlation arithmetic operation between the correlation windows W10a and W20a is Ca, a correlation coefficient at the correlation arithmetic operation between the correlation windows W10b and W20b is Cb, a correlation coefficient at the correlation arithmetic operation between the correlation windows W10c and W20c is Cc, a correlation coefficient at the correlation arithmetic operation between the correlation windows W10d and W20d is Cd, and a correlation coefficient at the correlation arithmetic operation between the correlation windows W10e and W20e is Ce, the displacement Xa is multiplied by a weighting factor corresponding to the correlation coefficient Ca, the displacement Xb is multiplied by a weighting factor corresponding to the correlation coefficient Cb, the displacement Xc is multiplied by a weighting factor corresponding to the correlation coefficient Cc, the displacement Xd is multiplied by a weighting factor corresponding to the correlation coefficient Cd, and the displacement Xe is multiplied by a weighting factor corresponding to the correlation coefficient Ce to thereby perform an average arithmetic operation. The weighting factors are assumed to be such factors as to become large as the correlation coefficients become higher.

Incidentally, the elastic image data generator 52 may generate elastic image data not based on the displacement Xc but based on the average value XAV, upon generation of elastic image data for the correlation windows W10c and W20c.

When the average value XAV is calculated by the average arithmetic unit 53, the physical quantity calculator 51 determines the amount of movement from the correlation window W20c, based on the average value XAV and thereby sets the correlation window W21c as shown in FIG. 6. The correlation window W21c set in this way has a portion overlaid on the correlation window W20c and is brought to a window width different from that of the correlation window W20c.

Here, the correlation window W11c may be set before the correlation window W21c is set, or may be set after the correlation window W21c has been set. When the correlation windows W11c and W21c are set, the physical quantity calculator 51 performs a correlation arithmetic operation between the correlation windows W11c and W21c to calculate a displacement.

Incidentally, correlation windows W2 are sequentially set similarly below from the upper end portion 100 to the lower end portion 101 on the sound ray L2c. Namely, upon setting the correlation windows on the sound ray L2c, an average arithmetic operation is performed on a displacement obtained between immediately preceding correlation windows on which a correlation arithmetic operation is performed just previously, and displacements obtained by correlation arithmetic operations among correlation windows for other sound rays (the sound rays L1a and L2a, sound rays L1b and L2b and sound rays L1d and L2d and sound rays L1e and L2e), which are located in the same depths as the immediately preceding correlation windows, so that the correlation windows W2 are sequentially set based on the so-obtained average displacement. The correlation windows W2 sequentially set to the echo signal S2 on the sound ray L2c from the upper end portion 100 to the lower end portion 101 in this way are not necessarily brought to the same window width and may have portions overlaid on one another.

According to the ultrasonic diagnostic apparatus 1 of the present embodiment described above, the correlation windows related to the frame (ii) are set in accordance with the correlation arithmetic operation on the immediately preceding correlation windows and the correlation windows on the other sound ray correlation windows. For example, the correlation window W21c is set based on the average value XAV of the displacement Xc obtained between the correlation windows W10c and W20c, the displacement Xa obtained between the correlation windows W10a and W20a, the displacement Xb obtained between the correlation windows W10b and W20b, the displacement Xd obtained between the correlation windows W10d and W20d, and the displacement Xe obtained between the correlation windows W10e and W20e. Thus, if the displacements Xa, Xb, Xd and Xe are those on which the elasticity of the biological tissue has been reflected more accurately, even where the displacement Xc obtained between the correlation windows W10c and W20c is not one on which the elasticity of the biological tissue has been reflected accurately, the correlation window W21c can be so set that the degree of matching with the correlation window W11c becomes high as compared with the case where the correlation window W21c is set based on only the displacement Xc as in the conventional case. Accordingly, it is possible to suppress the appearance of linear artifacts on an elastic image and obtain an elastic image on which the elasticity of the biological tissue has been reflected more accurately than ever before.

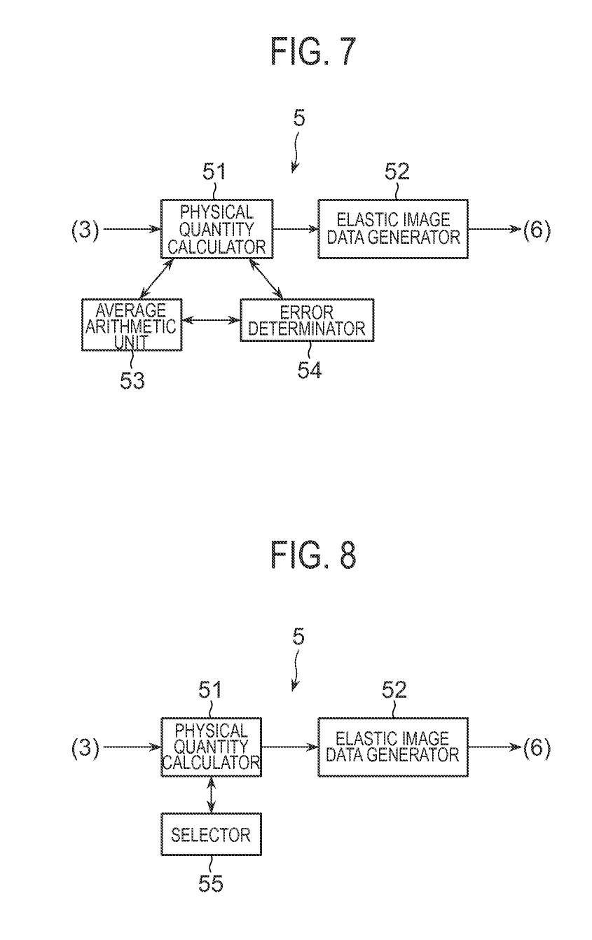

A modification of the first embodiment will next be explained. In the modification, the elastic image processing unit 5 further has an error determinator 54 as shown in FIG. 7. Upon executing of the average arithmetic operation by the average arithmetic unit 53, the error determinator 54 determines whether the displacements used for the average arithmetic operation are in error with being targeted for the displacements (error determining function). The average arithmetic unit 53 performs an average arithmetic operation except for the displacements determined to be in error. The error determinator 54 is one example of an embodiment of an error determinator in the invention.

For example, the error determinator 54 determines whether upon execution of the average arithmetic operation on the displacements Xa, Xb, Xc, Xd and Xe, these displacements Xa through Xe are errors. Then, the average arithmetic unit 53 performs an average arithmetic operation except for the displacements determined to be in error at the error determinator 54, of the displacements Xa through Xe. Namely, when any of Xa, Xb, Xd and Xe corresponding to the displacements obtained by the correlation arithmetic operations on the other sound ray correlation windows is determined to be in error, the average arithmetic unit 53 performs an average arithmetic operation on the displacements at the other sound ray correlation windows excluding the displacement determined to be in error, and the displacement Xc at the immediately preceding correlation windows. When the displacement Xc is determined to be in error, the average arithmetic unit 53 performs an average arithmetic operation on the displacements Xa, Xb, Xd and Xe.

Incidentally, the error determination about the displacement Xc may be performed before the generation of elastic image data about the correlation windows W10c and W20c. In this case, when the displacement Xc is determined to be in error, the elastic image data generator 52 may generate elastic image data, not based on the displacement Xc but based on the average value of the displacements Xa, Xb, Xd and Xe, upon generation of the elastic image data for the correlation windows W10c and W20c.

As one example of a method for making a displacement decision by the error determinator 54, there is mentioned a method for determining, based on a correlation coefficient C (0<C<1) at a correlation arithmetic operation by which a displacement target for determination is obtained, whether the displacement is in error. In this case, a predetermined threshold value C_{TH} is set in advance with respect to the correlation coefficient C. When the correlation coefficient C is smaller than the threshold value C_{TH}, the error determinator 54 determines the displacement as an error. For example, when the error determinator 54 determines whether the displacement Xa is in error, it compares a correlation coefficient Ca at a correlation arithmetic operation performed between the correlation windows W10a and W20s with the threshold value C_{TH}. When the correlation coefficient Ca is lower than the threshold value C_{TH}, the error determinator 54 determines the displacement Xa as an error.

As another method for making a displacement decision by the error determinator 54, there is mentioned a method for determining that a displacement target for determination is an error where it does not fall within a predetermined range set in advance. Here, the predetermined range is of a range set by, for example, an operator and used for each displacement that the operator considers acquirable normally.

Further, as a further method for making a displacement decision by the error determinator 54, there is mentioned a method for determining based on a distribution of other displacements to be targeted for determination whether a displacement to be targeted for determination is in error. Described specifically, when the displacement targeted for determination is markedly different with respect to the distribution of other displacements to be targeted for determination, the error determinator 54 determines that it is in error. A range in which the displacement is determined to differ markedly is set in advance by an operator's decision.

For example, when it is determined whether the displacement Xa is in error, the error determinator 54 determines an average value of the displacements Xb, Xc, Xd and Xe. When the displacement Xa does not fall within a range of ±n % set with respect to the average value by the operator, the error determinator 54 determines it to be in error. Thus, the error determinator 54 determines based on the distribution of the displacements Xb, Xc, Xd and Xe whether the displacement is in error.

### Second Embodiment

A second embodiment will next be described. The second embodiment is identical to the first embodiment in basic configuration, and description of items similar to those in the first embodiment will be omitted.

Although even in the present embodiment, the physical quantity calculator 51 sets the correlation windows for the frame (i) in accordance with the correlation arithmetic operation on the immediately preceding correlation windows and the correlation arithmetic operations on the other sound ray correlation windows in a manner similar to the first embodiment, the present embodiment is different therefrom in a concrete setting method.

Described concretely, as shown in FIG. 8 in the present embodiment, the elastic image processing unit 5 has a selector 55 in addition to the physical quantity calculator 51 and the elastic image data generator 52. The selector 55 selects a displacement suitable for the setting of each of the correlation windows out of the displacement for the immediately preceding correlation windows and the displacements obtained by the correlation arithmetic operations on the other sound ray correlation windows (selecting function). The selector 55 is one example of an embodiment of a selector in the invention. The physical quantity calculator 51 sets the corresponding correlation windows at the frame (ii), based on the displacement selected by the selector 55. Incidentally, the setting of the correlation windows at the frame (i) is similar to the first embodiment.

For example, when the correlation coefficient at the correlation arithmetic operation on the immediately preceding correlation windows exceeds a predetermined threshold value, the selector 55 selects a displacement obtained by the correlation arithmetic operation on the immediately preceding correlation windows as the displacement suitable for the setting of each of the correlation windows. On the other hand, when the correlation coefficient at the correlation arithmetic operation on the immediately preceding correlation windows is less than or equal to the predetermined threshold value, the selector 55 selects a displacement obtained by a correlation arithmetic operation on each correlation coefficient higher than the correlation coefficient at the correlation arithmetic operation on the immediately preceding correlation windows at the other sound ray correlation windows as the displacement suitable for the setting of each of the correlation windows.

Described concretely, when a correlation coefficient Cc at the correlation arithmetic operation between the correlation windows W10c and W20c exceeds the threshold value C_{TH} where the correlation window W21c is set, the displacement selected by the selector 55 is a displacement Xc obtained between the correlation windows W10c and W20c, and the physical quantity calculator 51 sets the correlation window W21c, based on the displacement Xc.

On the other hand, when the correlation coefficient Cc is less than or equal to the threshold value C_{TH}, the selector 55 compares a correlation coefficient Cb at a correlation arithmetic operation done between the correlation windows W10b and W20b at the sound rays L1b and L2b corresponding to sound rays adjoining to the left sides of the correlation windows L1c and L2c with the correlation coefficient Cc. When the correlation coefficient Cb is higher than the correlation coefficient Cc, the selector 55 selects a displacement Xb obtained between the correlation windows W10b and W20b as the displacement for setting the correlation window W21c. On the other hand, when the correlation coefficient Cb is less than or equal to the correlation coefficient Cc, the selector 55 compares a correlation coefficient Cd at a correlation arithmetic operation performed between the correlation windows W10d and W20d at the sound rays L1d and L2d corresponding to sound rays adjoining to the right sides of the sound rays L1c and L2c with the correlation coefficient Cc. When the correlation coefficient Cd is higher than the correlation coefficient Cc, the selector 55 selects a displacement Xd obtained between the correlation windows W10d and W20d as the displacement for setting the correlation window W21c. On the other hand, when the correlation coefficient Cd is less than or equal to the correlation coefficient Cc, the selector 55 further repeats the above processing on different sound rays and selects a displacement obtained by a correlation arithmetic operation by which a correlation coefficient higher than the correlation coefficient Cc is brought about, as the displacement for setting the correlation window W21c.

When, however, the correlation coefficient Cc is less than or equal to the threshold value C_{TH}, the selector 55 may select a displacement obtained by a correlation arithmetic operation related to the highest correlation coefficient (higher than the correlation coefficient Cc) of the correlation coefficients Ca, Cb, Cd and Ce as the displacement for setting the correlation window W21c.

When the correlation coefficient Cc is less than or equal to the threshold value C_{TH}, the selector 55 may select any displacement lying within a predetermined range set in advance, of the displacements Xa, Xb, Xd and Xe as the displacement for setting the correlation window W21c.

According to the present embodiment described above, for example, the correlation window W21c is set based on the displacement selected by the selector 55 out of the displacement Xc obtained by the correlation arithmetic operation between the correlation windows W10c and W21c and the displacements obtained by the correlation arithmetic operations among the other sound ray correlation windows (the correlation windows W10b and W20b, the correlation windows W10d and W20d, etc.). Thus, if each of the displacements obtained by the correlation arithmetic operations among the other sound ray correlation windows is one on which the elasticity of the biological tissue has been reflected more accurately, even where the displacement Xc is not one on which the elasticity of the biological tissue has been reflected accurately, this displacement is selected as the displacement suitable for the setting of the correlation window W21c. Consequently, the correlation window W21c can be set in such a manner that the degree of matching with the correlation window W11c becomes higher than conventional. It is thus possible to suppress the appearance of linear artifacts on the elastic image and acquire the elastic image on which the elasticity of the biological tissue has been reflected more accurately than conventional.

Modifications of the second embodiment will next be explained. The first modification will first be described. The selector 55 may select a displacement obtained by a correlation arithmetic operation for the highest correlation coefficient of the correlation coefficient at the correlation arithmetic operation on the immediately preceding correlation windows and the correlation coefficients at the correlation arithmetic operations on the other sound ray correlation windows, as a displacement suitable for the setting of each correlation window. For example, the selector 55 selects, as the displacement for setting the correlation window W21c, a displacement obtained by a correlation arithmetic operation for the highest correlation coefficient of the correlation coefficient Ca at the correlation arithmetic operation between the correlation windows W10a and W20a, the correlation coefficient Cb at the correlation arithmetic operation between the correlation windows W10b and W20b, the correlation coefficient Cc at the correlation arithmetic operation between the correlation windows W10c and W20c, the correlation coefficient Cd at the correlation arithmetic operation between the correlation windows W10d and W20d and the correlation coefficient Ce at the correlation arithmetic operation between the correlation windows W10e and W20e.

The second modification will next be described. In the second modification, when the corresponding displacement obtained by the correlation arithmetic operation between the immediately preceding correlation windows is of a displacement lying within a predetermined range, the selector 55 selects this displacement as the displacement suitable for the setting of each correlation window. On the other hand, when the displacement obtained by the correlation arithmetic operation between the immediately preceding correlation windows is of a displacement lying beyond the predetermined range, the selector 55 selects each of displacements obtained by the correlation arithmetic operations among the other sound ray correlation windows and lying within the predetermined range as the displacement suitable for the setting of each of the correlation windows.

When the displacement Xc obtained by the correlation arithmetic operation between the correlation windows W10c and W20c falls within a predetermined range set in advance upon setting the correlation window W21c, for example, the selector 55 selects this displacement Xc as the displacement for setting the correlation window W21c.

On the other hand, when the displacement Xc obtained by the correlation arithmetic operation between the correlation windows W10c and W20c falls beyond the predetermined range, the selector 55 selects any lying within the predetermined range, of the displacements Xa, Xb, Xd and Xe as the displacement for setting the correlation window W21c. In this case, the selector 55 may arbitrarily select any of the displacements Xa, Xb, Xd and Xe, which is obtained by such a correlation arithmetic operation that the correlation coefficient becomes higher than the correlation coefficient Cc. The selector 55 may select the displacement lying in the displacements Xa, Xb, Xd and Xe, which is obtained by the correlation arithmetic operation for the highest correlation coefficient, of the correlation arithmetic operations for the correlation coefficients higher than the correlation coefficient Cc.

Incidentally, the predetermined range is of a range set by, for example, an operator and used for each displacement that the operator considers acquirable normally.

The third modification will next be explained. The selector 55 determines based on a distribution of displacements obtained by correlation arithmetic operations among other sound ray correlation windows about a plurality of the other sound rays, whether the displacement obtained by the correlation arithmetic operation between the immediately preceding correlation windows is suitable for the setting of each of the correlation windows. When the displacement obtained by the correlation arithmetic operation between the immediately preceding correlation windows is not one substantially different with respect to the distribution of the displacements obtained by the correlation arithmetic operations among the other sound ray correlation windows, the selector 55 selects the displacement obtained by the correlation arithmetic operation between the immediately preceding correlation windows as the corresponding displacement suitable for the setting of each of the correlation windows. On the other hand, when the displacement obtained by the correlation arithmetic operation between the immediately preceding correlation windows is markedly different with respect to the distribution of the displacements obtained by the correlation arithmetic operations among the other sound ray correlation windows, the selector 55 selects each of the displacements obtained by the correlation arithmetic operations among the other sound ray correlation windows and lying within a predetermined range as the corresponding displacement suitable for the setting of each of the correlation windows. Incidentally, a range determined to differ markedly is set in advance by an operator's decision.

When the displacement Xc obtained by the correlation arithmetic operation between the correlation windows W10c and W20c falls within a range of ±n % set by the operator with respect to the average value of the displacements Xa, Xb, Xd and Xe upon setting the correlation window W21c, for example, the displacement Xc is selected as a correlation window suitable for the setting of the correlation window W21c.

On the other hand, when the displacement Xc does not fall within the range of ±n % set by the operator with respect to the average value of the displacements Xa, Xb, Xd and Xe, a displacement corresponding to any of the displacements Xa, Xb, Xd and Xe and lying within a predetermined range set in advance is selected as the corresponding correlation window suitable for the setting of the correlation window W21c. In this case, any of the displacements Xa, Xb, Xd and Xe, which is obtained by the corresponding correlation arithmetic operation for a correlation coefficient higher than the correlation coefficient Cc or a correlation coefficient exceeding a predetermined threshold value C_{TH}, may be selected arbitrarily. Alternatively, a displacement obtained by a correlation arithmetic operation highest in correlation coefficient, of correlation arithmetic operations for correlation coefficients higher than the correlation coefficient Cc may be selected. Any lying within the predetermined range set in advance may be selected out of the displacements Xa, Xb, Xd and Xe.

While the invention has been described above by the respective embodiments, the invention can of course be changed in various ways within the scope not departing from the gist thereof. For example, the physical quantity calculator 51 may calculate distortion of a biological tissue or its elastic modulus as a physical quantity related to the elasticity of the biological tissue instead of the displacement due to the deformation of the biological tissue.

In the second embodiment, when the displacement Xc is not selected as the displacement suitable for the setting of the correlation window W2 lc, the elastic image data generator 52 may generate elastic image data not based on the displacement Xc but based on the displacement selected as one suitable for the setting of the correlation window W21c, upon generation of the elastic image data for the correlation windows W10c and W20c.

Many widely different embodiments of the invention may be configured without departing from the spirit and the scope of the present invention. It should be understood that the present invention is not limited to the specific embodiments described in the specification, except as defined in the appended claims.

1. An ultrasonic diagnostic apparatus comprising:
a physical quantity calculator configured to:
set correlation windows to two echo signals obtained by transmission/reception of ultrasound to and from a biological tissue and lying on the same sound rays which belong to two frames acquired at different times; and
perform a correlation arithmetic operation between the correlation windows to calculate a physical quantity related to elasticity of the biological tissue; and
an elastic image data generator configured to generate elastic image data of the biological tissue, based on the physical quantity,
wherein upon setting each correlation window to the echo signal on one sound ray which belongs to either of the two frames, the physical quantity calculator is configured to set each correlation window in accordance with the correlation arithmetic operation on an immediately preceding correlation window adjacent to the correlation window on a first sound ray and subjected to the correlation arithmetic operation just previously, and the correlation arithmetic operation on a correlation window on a second sound ray different from the first sound ray.

2. The ultrasonic diagnostic apparatus according to claim 1, further comprising an average arithmetic unit configured to perform an average arithmetic operation on a first calculated value obtained by the correlation arithmetic operation on the immediately preceding correlation window and a second calculated value obtained by the correlation arithmetic operation on the second sound ray correlation window upon the setting of each correlation window on the first sound ray,
wherein the physical quantity calculator is configured to set the correlation window, based on an average value obtained by the average arithmetic unit.

3. The ultrasonic diagnostic apparatus according to claim 2, wherein the average arithmetic unit is configured to perform the average arithmetic operation on calculated values obtained by correlation arithmetic operations on the second sound ray correlation window about a plurality of additional sound rays and calculated values each obtained by the correlation arithmetic operation on the immediately preceding correlation window.

4. The ultrasonic diagnostic apparatus according to claim 3, further comprising an error determinator configured to determine whether each of the calculated values obtained by the correlation arithmetic operations on the second sound ray correlation window is in error,
wherein the average arithmetic unit is configured to perform the average arithmetic operation except for the calculated value of error.

5. The ultrasonic diagnostic apparatus according to claim 1, further comprising an error determinator configured to determine whether the calculated value obtained by the correlation arithmetic operation on the immediately preceding correlation window is in error, and
an average arithmetic unit configured to perform an average arithmetic operation, when it is determined by the error determinator that the calculated value obtained by the correlation arithmetic operation on the immediately preceding correlation window is in error upon the setting of the correlation window on the first sound ray, the average arithmetic operation performed on the calculated values obtained by the correlation arithmetic operations on the second sound ray correlation window about a plurality of additional sound rays,
wherein the physical quantity calculator is configured to set the correlation window, based on an average value obtained by the average arithmetic unit.

6. The ultrasonic diagnostic apparatus according to claim 4, wherein the error determinator is further configured to determine whether the calculated value is in error, based on a correlation coefficient obtained via the correlation arithmetic operation by which a calculated value targeted for determination is obtained.

7. The ultrasonic diagnostic apparatus according to claim 4, wherein the error determinator is further configured to determine that a calculated value targeted for determination is in error when the calculated value falls beyond a predetermined range.

8. The ultrasonic diagnostic apparatus according to claim 4, wherein the error determinator is further configured to determine whether a calculated value targeted for determination is in error, based on a distribution of other calculated values target for determination.

9. The ultrasonic diagnostic apparatus according to claim 2, wherein the average arithmetic unit is further configured to assign weights corresponding to correlation coefficients to the calculated values, respectively, targeted for the average arithmetic operation.

10. The ultrasonic diagnostic apparatus according to claim 1, further comprising a selector configured to select a calculated value suitable for setting each correlation window based on the first calculated value obtained by the correlation arithmetic operation on the immediately preceding correlation window and the second calculated value obtained by the correlation arithmetic operation on the second sound ray correlation window upon the setting of the correlation window on the first sound ray,
wherein the physical quantity calculator is configured to set the correlation window, based on the calculated value selected by the selector.

11. The ultrasonic diagnostic apparatus according to claim 10, wherein the selector is further configured to select the calculated value suitable for the setting of the correlation window, based on a correlation coefficient using the correlation arithmetic operation by which the calculated value is obtained or whether the calculated value falls within a predetermined range.

12. The ultrasonic diagnostic apparatus according to claim 10, wherein when the corresponding correlation coefficient at the correlation arithmetic operation on the immediately preceding correlation windows exceeds a predetermined threshold value, the selector is configured to select the calculated value obtained by the correlation arithmetic operation on the immediately preceding correlation windows as the calculated value suitable for the setting of each of the correlation windows; and
when the corresponding correlation coefficient at the correlation arithmetic operation on the immediately preceding correlation windows is less than or equal to the predetermined threshold value, the selector is configured to select the calculated value obtained using the correlation arithmetic operation for a correlation coefficient higher than the correlation coefficient at the correlation arithmetic operation on the immediately preceding correlation windows or a calculated value lying within a predetermined range, the calculated value corresponding to the calculated value obtained by the correlation arithmetic operation on the second sound ray correlation windows, as the calculated value suitable for the setting of each of the correlation windows.

13. The ultrasonic diagnostic apparatus according to claim 10, wherein the selector is configured to select the calculated value obtained using the correlation arithmetic operation for a highest correlation coefficient of the correlation coefficient at the correlation arithmetic operation on the immediately preceding correlation windows and the correlation coefficients at the correlation arithmetic operations on the second sound ray correlation windows, as the calculated value suitable for the setting of each of the correlation windows.

14. The ultrasonic diagnostic apparatus according to claim 10, wherein when the calculated value obtained by the correlation arithmetic operation on the immediately preceding correlation windows falls within a predetermined range, the selector is configured to select the calculated value obtained by the correlation arithmetic operation on the immediately preceding correlation windows as the calculated value suitable for the setting of each of the correlation windows; and
when the calculated value obtained by the correlation arithmetic operation on the immediately preceding correlation windows falls beyond the predetermined range, the selector is configured to select, as the calculated value suitable for the setting of each of the correlation windows, a calculated value obtained using the correlation arithmetic operation for a correlation coefficient higher than the correlation coefficient at the correlation arithmetic operation on the immediately preceding correlation windows or a calculated value lying within the predetermined range, the calculated value corresponding to each of the calculated values obtained by the correlation arithmetic operation on the second sound ray correlation window.

15. The ultrasonic diagnostic apparatus according to claim 10, wherein the selector is further configured to determine based on a distribution of calculated values obtained by correlation arithmetic operations on the other sound ray correlation windows about a plurality of the other sound rays, whether the calculated value obtained by the correlation arithmetic operation on the immediately preceding correlation windows is suitable for the setting of each of the correlation windows, such that when it is determined that the calculated value is suitable for the setting of each of the correlation windows, the selector is configured to select the calculated value obtained by the correlation arithmetic operation on the immediately preceding correlation windows as the calculated value suitable for the setting of each of the correlation windows; and
when it is determined that the calculated value is unsuitable for the setting of each of the correlation windows, the selector is configured to select, as the calculated value suitable for the setting of each of the correlation windows, a calculated value obtained by the correlation arithmetic operation for a correlation coefficient higher than the correlation coefficient at the correlation arithmetic operation on the immediately preceding correlation windows or a calculated lying within the predetermined range, the calculated value corresponding to any of the calculated values obtained by the correlation arithmetic operations on the second sound ray correlation window.

16. The ultrasonic diagnostic apparatus according to claim 1, wherein the second sound ray correlation window is located in a same depth as the immediately preceding correlation windows in the biological tissue.

17. A control program for an ultrasonic diagnostic apparatus, the control program stored on a storage unit of a computer and comprising:
a physical quantity calculating function configured to cause the computer to set correlation windows to two echo signals obtained by transmission/reception of ultrasound to and from a biological tissue and lying on the same sound rays which belong to two frames different in time and further configured to cause the computer to perform a correlation arithmetic operation between the correlation windows to thereby calculate a physical quantity related to elasticity of the biological tissue; and
an elastic image data generating function configured to cause the computer to generate elastic image data of the biological tissue, based on the physical quantity,
wherein upon setting each correlation window to the echo signal on a first sound ray which belongs to either one of the two frames, the physical quantity calculating function is configured to cause the computer to set the correlation window in accordance with the correlation arithmetic operation on an immediately preceding correlation window adjacent to the correlation window on the first sound ray and subjected to the correlation arithmetic operation just previously, and the correlation arithmetic operation on a correlation window on a second sound ray different from the first sound ray.

18. The control program according to claim 17, further an average computing function configured to cause the computer to perform an average arithmetic operation on a first calculated value obtained by the correlation arithmetic operation on the immediately preceding correlation window and a second calculated value obtained by the correlation arithmetic operation on the second sound ray correlation window upon the setting of the each correlation window on the first sound ray,
wherein the physical quantity calculating function is configured to cause the computer to set the correlation window, based on an average value obtained by the average computing function.

19. The control program according to claim 17, further comprising an error determining function configured to cause the computer to determine whether the calculated value obtained by the correlation arithmetic operation on the immediately preceding correlation window is in error, and
an average computing function configured to cause the computer to perform an average arithmetic operation, when it is determined by the error determining function that the calculated value obtained by the correlation arithmetic operation on the immediately preceding correlation window is in error upon the setting of each correlation window on the first sound ray, the average arithmetic operation performed on the second calculated value obtained by the correlation arithmetic operations on the second sound ray correlation window about a plurality of additional sound rays,
wherein the physical quantity calculating function is configured to cause the computer to set the correlation window, based on an average value obtained by the average computing function.

20. The control program according to claim 17, further comprising a selecting function configured to cause the computer to select a calculated value suitable for the setting of each correlation window out of the first calculated value obtained by the correlation arithmetic operation on the immediately preceding correlation window and the second calculated value obtained by the correlation arithmetic operation on the second sound ray correlation window upon the setting of each correlation window on the first sound ray,
wherein the physical quantity calculating function is configured to set the correlation window, based on the calculated value selected by the selecting function.
